(19) United States
(12) Patent Application Publication
(10) Pub. No.: US 2016/0137852 A1
(43) Pub. Date: May 19, 2016

(54) ANTI-FINGERPRINT TREATMENT REAGENT AND METHOD PROCESSING THE SAME

(71) Applicant: Xiamen Runner Industrial Corporation, Xiamen (CN)

(72) Inventors: Zhi-Min Lin, Xiamen (CN); Sheng-Jie Liu, Xiamen (CN); Ze-Feng Yu, Xiamen (CN); Ying-Wei Xie, Xiamen (CN)

(21) Appl. No.: 14/941,531

(22) Filed: Nov. 13, 2015

(30) Foreign Application Priority Data
Nov. 18, 2014 (CN) 201410673362.7

(51) Int. Cl. C09D 5/16; C08K 5/17; C08K 5/41; B05D 1/18; C08K 5/098; B05D 1/02; B05D 1/28; C08K 5/5419; C08K 3/22

(52) U.S. Cl. CPC C09D 5/16; C08K 5/5419; C08K 5/17; C08K 5/41; C08K 3/22; C08K 5/098; B05D 1/02; B05D 1/28; B05D 1/18; C08K 2003/2255; C08K 2003/2258

(57) ABSTRACT

An anti-fingerprint treatment reagent has an organic polydimethlysiloxane, a solvent and an additive. A surface of a metal base material is treated by the organic polydimethlysiloxane. The surface treated with the anti-fingerprint reagent is fingerprint-resistant for being hydro-oleophobic. The coating of thanti-fingerprint treatment reagent is too thin to be seen, and will not affect the optical properties and function of the surface of the base material. The anti-fingerprint treatment reagent is inexpensive, simple in treatment process, reusable and practical. Especially, the anti-fingerprint reagent fits to avoid a product surface having pollution likes water spot, sweat, fingerprint and the like.

### BACKGROUND OF THE INVENTION

1. Field of the Invention

The present invention relates to a surface treatment reagent and, more particularly, an anti-fingerprint treatment reagent and a method processing the same that avoid generation of fingerprint on metal surface.

2. Description of the Related Art

Surface of product is easily deposited with water spots and grease from workers' sweat during manufacturing processes. Such contamination thus greatly affects quality of product and causes economic losses. Currently, anti-fingerprint coating is usually employed to avoid the issues of water spots, sweat grease and fingerprint deposited on surface of product. Other methods for coating on the surface include Physical Vapor Deposition (PVD) and Chemical Vapor Deposition (CVD).

Fluoro Silane (H₃FSi, FS) has characteristics like minimal surface tension, and good hydro-oleophobicity against fingerprint. Therefore, FS has been widely used in coating on surface to avoid fingerprint left on surface. For example, FS materials with low surface energy can be plated on display panel or shell of cellular phone by PVD, or plated on steel plate by Wet Chemistry for generating a fingerprint-resistant steel plate.

There are a couple of methods for preparing an organic FS coating pre-coated on a metal plate. A first method is to wash a surface of a metal plate with plasma since plasma enhances performance of Chemical Vapor Deposition (CVD), and coat a heated FS material on the metal plate to provide better hydrophobicity. A second method is to make an anti-corrosion and fingerprint-resistant treatment reagent whose composition includes organic polymer resin with a weight percent in 7 to 45%, organic silicon resin solution with a weight percent in 2 to 15%, water wax with a weight percent in 0.5 to 10%, nano-oxide with a weight percent in 0.5 to 10%, metal compound with a weight percent in 0.1 to 20%, silane mixture with a weight percent in 0.1 to 15% and water. A third method is to prepare a hydrophobic hydrocarbon coating material, which is prepared by mixing an acid-sintered nano SiO₂ particles with methoxysilane to form a primer paint, and coating a hydrocarbon coating on the primer paint, such that the static water contact angle is 138° under an optimized condition.

However, using PVD and CVD demands for conditions of high temperature, high power, long processing cycle and high cost, thus limiting the applicability. Although the coating material prepared by Wet Chemistry method does not affect the quality of the coating material, the composition of the fingerprint-resistant treatment reagent is complex, and the coating on the product is thick as visually perceived. Even though transmittance through the coating is high, such product won't be aesthetically appealing and is therefore hard to meet strict demands for color and luster of the appearance of many products.

Accordingly, it is important to develop a new anti-fingerprint treatment reagent that do not cause aesthetic issue in appearance and can be manufactured in a simple and fast way.

### SUMMARY OF THE INVENTION

In view of the problems and drawbacks of the prior art, the objective of the present invention is to provides a anti-fingerprint treatment reagent and a method processing the same. The surface treated with the anti-fingerprint treatment reagent is hydro-oleophobic, fingerprint resistant and corrosion-resistant. The nano-size film formed by the anti-fingerprint treatment reagent on the surface does not influences optical properties and functional tests of the surface. Material of the anti-fingerprint treatment reagent are inexpensive and easy to get. The method processing the anti-fingerprint treatment reagent is simple in operation and practical, and has good repeatability. Especially, the anti-fingerprint treatment reagent fits to prevent product surface from being polluted by water spot, sweat, fingerprint and the like.

To achieve the foregoing objective, the anti-fingerprint treatment reagent includes organic polydimethlysiloxane having a weight percent in 0.001˜30%, solvent having a weight percent in 60˜99.99% and additive having a weigh percent in 0.001˜10%, and a total weight percent of the organic polydimethylsiloxane, the solvent and the additive is 100%.

Preferably, the organic polydimethlysiloxane includes at least one of fluoropolysioxane, ethenylpolysiloxane, phenylpolysiloxane, epoxypolysiloxane, an aminopolysiloxane and a mercaptopolysiloxane.

Preferably, the solvent includes at least one of water or ethanol.

Preferably, the additive includes at least one of sodium dodecyl benzene sulfonate, triethanolamine, tetramethylazanium hydroxide, hexadecylamine, sodium benzoate, ethylenediaminetetraacetic acid disodium salt, amino acid sodium, sodium gluconate, sodium silicate, sodium molybdenum oxide, sodium tungstate(VI), sodium tin(IV) oxide and sodium metasilicate.

To achieve the foregoing objective, a method processing the anti-fingerprint treatment reagent having a composition of organic polydimethlysiloxane, solvent and additive, includes steps of:
coating the anti-fingerprint treatment reagent on a surface of a base material; and
drying the anti-fingerprint treatment on the surface in a temperature range 20˜200° C.

Preferably, the step of coating the anti-fingerprint treatment reagent on the surface of the base material includes one of soaking the base material into the anti-fingerprint reagent, using a spray gun to spray the anti-fingerprint reagent on the base material, using a brush to paint the anti-fingerprint reagent on the base material, and rolling the anti-fingerprint reagent on the base material.

Preferably, the base material is a metal coating on a metal material or a non-metallic material.

The anti-fingerprint treatment reagent in accordance with the present invention have the following advantages over conventional surface treatment reagent:
1. A much thinner coating without compromising color and luster of appearance of product.
2. Good hydrophobicity.
3. The organic polydimethlysiloxane enhances the binding with metal and nonmetallic materials, such that the reagent has stronger binding effect on a product.
4. One of Sodium molybdenum oxide and Sodium tin(IV) oxide of the anti-fingerprint treatment reagent is corrosion-resistant, such that an external surface of a product coated with the anti-fingerprint treatment reagent is also corrosion-resistant.
5. The step of coating the anti-fingerprint treatment reagent on the product is performed after a normal coating process of the product. As no additional production line is required, cost down in production is ensured.
6. More simple in production with better repeatability.

### BRIFE DESCRIPTION OF THE DRAWINGS

The detailed description of the drawings particularly refers to the accompanying figures in which:

FIG. 1 is a picture of two pull type faucets with only one of the pull type faucets coated with a anti-fingerprint treatment reagent; and

FIG. 2 is a picture of a water drop test on the two pull type faucets in FIG. 1.

### DETAILED DESCRIPTION OF THE INVENTION

The present invention is described in details by the following embodiments and figures to clarify the production method for the anti-fingerprint treatment reagent.

In preparation for a common type of anti-fingerprint treatment reagent, the anti-fingerprint treatment reagent has the following composition in weight percent: 0.001˜30% organic polydimethlysiloxane, 60˜99.99% solvent and 0.001˜10% additive, the total weight percentage is 100%.

The organic polydimethlysiloxane may be one or a compound of at least twoof fluoropolysioxane, ethenylpolysiloxane, phenylpolysiloxane, epoxypolysiloxane, aminopolysiloxane and mercaptopolysiloxane.

The solvent includes at least one of water and ethanol.

The additive may be one or a compound of at least two of sodium dodecyl benzene sulfonate, Triethanolamine, tetramethylazanium hydroxide, Hexadecylamine, Sodium benzoate, Ethylenediaminetetraacetic acid disodium salt, Amino Acid Sodium, Sodium gluconate, sodium silicate, Sodium molybdenum oxide, Sodium tungstate(VI), Sodium tin(IV) oxide and Sodium metasilicate.

Using the above-mentioned reagent to produce the surface treatment reagent coated on a base material, the coating method includes steps of soaking the base material into the anti-fingerprint treatment reagent, using spray gun to brush or to roll the soaked base material, and drying the material in 20˜200° C. The base material may be a metal coating on a metal material or a non-metallic material.

### Embodiment 1

In preparation for a common type of anti-fingerprint treatment reagent, the anti-fingerprint treatment reagent has the following composition in weight percent: water 90%, (3,3,3-Trifluoropropyl) trimethoxysilane 5%, sodium dodecyl benzene sulfonate 2% and Triethanolamine 3%. Mix all ingredients of anti-fingerprint reagent evenly, soak a pull-type faucet into the anti-fingerprint treatment reagent for 1 to 10 minutes, and dry out the pull-type faucet at 60° C.

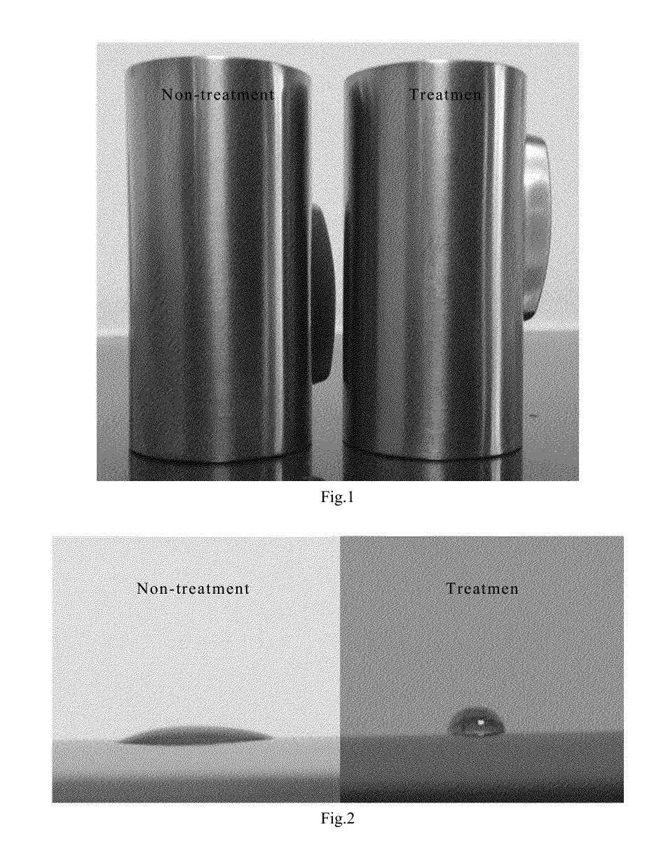

With reference to FIG. 1, two pull type faucets treated and not treated with the anti-fingerprint treatment reagent are shown for comparison.

With reference to FIG. 2, a water drop test is carried out on the two pull type faucets, a static water contact angle on a surface of the pull type faucet treated with the anti-fingerprint treatment reagent is bigger than a surface of the pull type faucet untreated with the anti-fingerprint treatment reagent.

### Embodiment 2

The present embodiment and the remaining embodiments differ from the embodiment only in that the pull-type faucet is changed to a sprinkle faucet. As being similar to the foregoing embodiment, operation of the present embodiment is not repeated here.

### Embodiment 3

In preparation for a common type of anti-fingerprint treatment reagent, the anti-fingerprint treatment reagent has the following composition in weight percent: water 95.99%, ethenyl triethoxysilane 0.005%, octadecylamine 0.005% sodium molybdenum oxide 2% and Sodium tin(IV) oxide 2%. Mix all ingredients of the anti-fingerprint reagent evenly, soak a sprinkle faucet into the anti-fingerprint treatment reagent for 1 to 10 min, and then dry out the sprinkle faucet at 60° C.

### Embodiment 4

In preparation for a common type of anti-fingerprint treatment reagent, the anti-fingerprint treatment reagent has the following composition: ethanol 60%, Ethenyl triethoxysilane 30%, Triethanolamine 5% and Sodium tungstate(VI) 5%. Mix all ingredients of the anti-fingerprint reagent evenly, soak a sprinkle faucet into the anti-fingerprint treatment reagent for 1 to 10 min, and then dry out the sprinkle faucet at 60° C.

### Embodiment 5

In preparation for a common type of anti-fingerprint treatment reagent, the anti-fingerprint treatment reagent has the following composition in weight percent: water 50%, ethanol 40%, Ethenyl triethoxysilane 8%, Sodium molybdenum oxide 1% and

Hexamethylenetetramine 1%. Mix all ingredients of the anti-fingerprint treatment reagent evenly, soak a sprinkle faucet into the anti-fingerprint treatment for 1 to 10 min, and then dry the sprinkle at 60° C.

### Embodiment 6

In preparation for a common type of anti-fingerprint treatment reagent, the anti-fingerprint treatment reagent has the following composition: water 80%, ethanol 10%, Ethenyl triethoxysilane 0.5%, Ethylenediaminetetraacetic acid disodium salt 2%, Sodium gluconate 2% and sodium amino acids 2%. Mix all ingredients of the anti-fingerprint reagent evenly, soak a sprinkle faucet into the anti-fingerprint reagent for 1 to 10 min, and then dry the sprinkle faucet at 60° C.

### Embodiment 7

In preparation for a common type of anti-fingerprint treatment reagent, the anti-fingerprint treatment reagent has the following composition: water 80%, ethanol 10%, Phenyltriethoxysilane 2%, epoxypolysiloxane 2%, Sodium tin(IV) oxide 0.5% and Sodium benzoate 0.5%. Mix all ingredients of the anti-fingerprint reagent evenly, soak a sprinkle faucet into the anti-fingerprint reagent for 1 to 10 min, then dry the sprinkle faucet at 60° C.

### Embodiment 8

In preparation for common type of anti-fingerprint treatment reagent, the anti-fingerprint treatment reagent has the following composition: water 90%, (3,3,3-Trifluoropropyl) trimethoxysilane 5%, sodium dodecyl benzene sulfonate 2% and Triethanolamine 3%. Mix all ingredients of the anti-fingerprint reagent evenly, spray the reagent on an outer surface of a sprinkle faucet surface using a spray gun, and then dry out the sprinkle faucet at 60° C. The spray gun is operated at 0.1 MPa air pressure, a distance from the spray spout of spray gun to the sprinkle faucet is 30 cm.

### Embodiment 9

In preparation for a common type of anti-fingerprint treatment reagent, the anti-fingerprint treatment reagent has the following composition: water 90%, (3,3,3-Trifluoropropyl) trimethoxysilane 50%, sodium dodecyl benzene sulfonate 2% and Triethanolamine 3%. Mix all ingredients of the anti-fingerprint reagent evenly, paint the reagent on an outer surface of the sprinkle faucet with a brush, and then dry out the sprinkle faucet at 60° C. The painting is performed at a speed 10 cm/mm, and the brush is moved back and forth for 3 to 5 times.

The anti-fingerprint treatment reagent in accordance with the present invention have the following advantages over conventional surface treatment reagent:
1. A much thinner coating without compromising color and luster of appearance of product.
2. Good hydrophobicity.
3. The organic polydimethlysiloxane enhances the binding with metal and nonmetallic materials, such that the reagent has stronger binding effect on a product.
4. One of Sodium molybdenum oxide and Sodium tin(IV) oxide of the anti-fingerprint treatment reagent is corrosion-resistant, such that an external surface of a product coated with the anti-fingerprint treatment reagent is also corrosion-resistant.
5. The step of coating the anti-fingerprint treatment reagent on the product is performed after a normal coating process of the product. As no additional production line is required, cost down in production is ensured.
6. More simple in production with better repeatability.

1. A anti-fingerprint treatment reagent comprising,
Organic polydimethlysiloxane;
Solvent; and
Additive.

2. The anti-fingerprint treatment reagent as claimed in claim 1, wherein the organic polydimethlysiloxane has a weight percent in a range of 0.001˜30%, the solvent has a weight percent in a range of 60.99.99%, the additive has a weight percent in a range of 0.001˜10%, and a total weight percent of the organic polydimethylsiloxane, the solvent and the additive is 100%.

3. The anti-fingerprint treatment reagent as claimed in claim 1, wherein the organic polydimethlysiloxane includes one of fluoropolysioxane, ethenylpolysiloxane, phenylpolysiloxane, epoxypolysiloxane, aminopolysiloxane and mercaptopolysiloxane.

4. The anti-fingerprint treatment reagent as claimed in claim 1, wherein the organic polydimethlysiloxane includes a compound of at least two of fluoropolysioxane, ethenylpolysiloxane, phenylpolysiloxane, epoxypolysiloxane, aminopolysiloxane and mercaptopolysiloxane.

5. The anti-fingerprint treatment reagent as claimed in claim 2, wherein the organic polydimethlysiloxane includes at least one of fluoropolysioxane, ethenylpolysiloxane, phenylpolysiloxane, epoxypolysiloxane, aminopolysiloxane and mercaptopolysiloxane.

6. The anti-fingerprint treatment reagent as claimed in claim 1, wherein the solvent includes at least one of water or ethanol.

7. The anti-fingerprint treatment reagent as claimed in claim 2, wherein the solvent includes at least one of water or ethanol.

8. The anti-fingerprint treatment reagent as claimed in claim 1, wherein the additive includes at least one of sodium dodecyl benzene sulfonate, triethanolamine, tetramethylazanium hydroxide, hexadecylamine, sodium benzoate, ethylenediaminetetraacetic acid disodium salt, amino acid sodium, sodium gluconate, sodium silicate, sodium molybdenum oxide, sodium tungstate(VI), sodium tin(IV) oxide and sodium metasilicate.

9. The anti-fingerprint treatment reagent as claimed in claim 2, wherein the additive includes at least one of sodium dodecyl benzene sulfonate, triethanolamine, tetramethylazanium hydroxide, hexadecylamine, sodium benzoate, ethylenediaminetetraacetic acid disodium salt, amino acid sodium, sodium gluconate, sodium silicate, sodium molybdenum oxide, sodium tungstate(VI), sodium tin(IV) oxide and sodium metasilicate.

10. A method processing the anti-fingerprint treatment reagent having a composition of
organic polydimethlysiloxane,
solvent and additive, the method comprising steps of:
coating the anti-fingerprint treatment reagent on a surface of a base material; and
drying the anti-fingerprint treatment on the surface in a temperature range 20˜200° C.

11. The method as claimed in claim 10, wherein the step of coating the anti-fingerprint treatment reagent on the surface of the base material includes one of soaking the base material into the anti-fingerprint reagent, using a spray gun to spray the anti-fingerprint reagent on the base material, using a brush to paint the anti-fingerprint reagent on the base material, and rolling the anti-fingerprint reagent on the base material.

12. The method as claimed in claim 10, wherein the base material is a metal coating on a metal material or a non-metallic material.
